(19) United States
(12) Patent Application Publication
(10) Pub. No.: US 2012/0021764 A1
(43) Pub. Date: Jan. 26, 2012

(54) System and Method for Robust Navigation and Communication Via A Cooperative Ad-hoc Network

(75) Inventor: Michael A. Enright, Huntington Beach, CA (US)

(73) Assignee: QUANTUM DIMENSION INC., Huntington Beach, CA (US)

(21) Appl. No.: 13/190,474

(22) Filed: Jul. 26, 2011

Related U.S. Application Data
(60) Provisional application No. 61/400,126, filed on Jul. 23, 2010.

(51) Int. Cl. H04W 64/00

(52) U.S. Cl. 455/456.1

(57) ABSTRACT

A MANET Signals of Opportunity (SoOP) network providing positioning information to mobile users cooperatively. Mobile nodes access SoOP/GNSS to determine location and share navigation and communication information with other users to extend coverage to adjacent nodes. The system also allows disadvantaged users to determine positioning based upon beacon information transmitted without access to GNSS signals.

### Cross References: N/A

Related US Application Data: Provisional application 61/400,126 filed on Jul. 23, 2010.

Federally Sponsored Research: The U.S. Government has rights pursuant to Air Force Contract numbers FA8650-10-C-1734 and FA8650-09-M-1581 awarded by the Air Force Research Lab, WPAFB, Ohio.

Sequence Listing or Program: Not applicable

1.0 Field of the Invention

This present innovation relates to a method and system for providing a cooperative navigation and a communication system that cooperatively shares information over a wireless network and utilizes a plurality of signal sources.

2.0 Description of the Related Art

The issues in obtaining robust navigation capabilities using GPS have been well documented over the past few decades. The majority of the prior art falls into two very distinctive categories with the majority of solutions employing GPS satellite signals combined with cellular networks for mobile device access. Navigation information is conveyed to the mobile devices in a variety of ways, but all rely entirely upon GPS receivers to provide said positioning data: U.S. Pat. No. 6,043,777 to Bergman, et al., entitled Method and Apparatus For Global Positioning System Based Cooperative Location System, U.S. Pat. No. 6,417,801 to van Diggelen, entitled Method and Apparatus For Time-Free Processing Of GPS Signals, U.S. Pat. No. 7,769,393 to Jendbro, et al., entitled Cooperative Global Positioning System (GPS) Processing by Mobile Terminals That Communicate Via an Ad Hoc Wireless Network, and U.S. Pat. No. 7,865,297 to Ruckart, entitled Methods For Obtaining A Navigation Track Between A First And A Second Location Based on Location Information Shared Between Peer Devices And Related Devices And Computer Program Products, all rely upon GPS receivers solely for navigational data transfer. However, numerous impediments to GPS accuracy exist that range from lack of sufficient received signal power to

penetrate buildings, susceptibility to multipath fading, jamming, frequency overlap, etc. Thus additional solutions have been developed to compensate for these issues: mitigation techniques such as differential GPS (DGPS) and assisted GPS (AGPS) have been developed to provide improvements under specific conditions. AGPS has been particularly helpful in outdoor environments for cellular mobile devices that have limited computational capability. U.S. Pat. No. 7,884,762 to Abraham, entitled Method and Apparatus For Receiving A Global Positioning System Signal Using A Cellular Acquisition Signal, U.S. Pat. No. 6,445,927 to King, et al., entitled Method And Apparatus For Calibrating Base Station Locations And Perceived Time Bias Offsets In An Assisted GPS Transceiver, U.S. Pat. No. 7,084,809 to Hockley, et al., entitled Apparatus And Method Of Position Determination Using Shared Information, and US Patent Application No. 2010/0328146, Xie et al., entitled Systems And Methods For Synthesizing GPS Measurements To Improve GPS Location Availability, all focus on a form of Assisted GPS to accomplish enhanced positioning within cellular/mobile devices The majority of prior art exploits GPS receivers coupled with fixed base stations or access points with known positions to triangulate terrestrial positioning for local users lacking dedicated GPS receivers. However all of these solutions, which are heavily dependent upon GPS satellites, suffer from the fundamental challenges of fading and jamming.

One area of advancement has been to improve the accuracy of navigation systems by employing signals of opportunity (SoOP). These signals are not navigation-specific and thus avoid the inherent challenges of GPS receiver-based solutions. Instead, radiofrequency (RF) signals are used for communication purposes that originate from the many wireless systems that are in place today. There are many advantages to using collaborative navigation schemes built on ad hoc wireless networks in the presence of SoOP that include higher received signal power and diversity in the signal space.

While the investigation of SoOP for navigation applications is a fairly new field, important research has been done regarding the various signals that can be employed. One of the earliest attempts and using SoOP was with relation to AM radio, T. Hall, “Radiolocation using AM broadcast signal: the role of signal propagation irregularities”, Proc. IEEE. Pos Loc. Nay. Sys. (PLANS) pp. 752-761, April 2004. AM radio has some advantageous properties but is susceptible to multiple sources of interference from overhead power lines and from ground wave propagation. It also is subject to integer ambiguity. Algorithms to resolve integer ambiguity have been addressed by a number of researchers, P. J. G. Teunissen, “Statistical GNSS carrier phase ambiguity resolution: a review”, Proc. IEEE Wksp. Stat. Signal Proc., pp. 4-12, August 2001 and E. De Weerdt, et al., “New Approach for integer ambiguity resolution using interval analysis”, Journal of Inst. For Navigation, vol. 55, no. 4, pp. 293-307, Winter 2008. To avoid issues related to AM radio, other signals have been investigated since these AM signals require sufficient bandwidth to allow for improved accuracy while not having the integer ambiguity problems that plague lower bandwidth systems.

Consequently, digital television (DTV) has met that requirement and several patents address the ability to utilize DTV including U.S. Pat. No. 6,717,547 to Spilker, et al, entitled Position Location Using Broadcast Television Signals And Mobile Telephone Signals and U.S. Pat. No. 6,859,173 to Spilker et al., entitled Position Location Using Broadcast Television Signals And Mobile Telephone Signals both which employ a wireless base station along with DTV signals and Mobile Telephone signals for providing positioning data. These referenced solutions suffer for several reasons. The lack of ad-hoc network capability is limited since transmission from DTV terminals can only be provide to mobile telephones only. Base station-only location information requires fixed location only and relies on DTV broadcast signals which do not provide sufficient diversity of signals for accurate positioning. US Patent Application No. 2011/0102264 to SIN, et al., as an example, focuses on utilizing an interior-based only DTV receiver and determines location based upon distance of device to the DTV the receiver. This application is limited to indoor solutions in close proximity to a DTV receiver. One large disadvantage of use of DTV signals alone for determining location cited in the three previous patents is the fact that in many metropolitan areas DTV transmitters tend to be co-located and do not provide sufficient signal diversity. Diversity is required to provide more accurate position information relative to the DTV broadcast towers. In the search for a more robust solution, the use of a combination of AM and DTV has been studied by both K. A. Fisher, “The navigational potential of signals of opportunity-based time difference of arrival measurements,” Ph.D. Dissertation, March 2004 and C. Yan and H. H. Fan, “Asynchronous differential TDOA for non-GPS navigation using signals of opportunity,” Proc. Int. Conf. Acoustics, Speech, Signal Proc. (ICASSP), pp. 5312-5315, April 2008 which both noted the same limitations as discussed previously.

One of the major causes of the degradation in navigation performance using SoOP comes from signal fading. This can manifest itself as a loss in SNR which ultimately leads to poor performance in physical layer issues such as in timing and frequency estimation. If the fading is too severe, it will cause the receiver to lose lock and the acquisition process must begin again. Not only does this reduce the system availability but it also requires the receiver to draw more power. This is a major issue since it has effects on the battery life of the mobile device.

Fading can come from multiple sources that include attenuation through structures such as walls and other objects, or it can occur as a result of multipath. Multipath can be partitioned into two groups: slow fading and fast fading. Slow fading occurs as the signal interferes over long distances. On the other hand fast, or carrier, fading occurs at shorter distances and is due to carriers adding destructively from many directions.

Cellular signals near the 1 GHz band and signals at higher carrier frequencies are particularly susceptible due to the short wavelength, such as 30 cm for a 1 GHz carrier. Clearly, as a user moves through the multipath field, they will experience periods of severely low signal power which can cause the receiver to lose lock. There have been number of fading models developed \cite{Lee92}, \cite{Jakes94} to quantify these effects. For cellular applications, 3GPP has specified fading models for GSM \cite{3GPP08} and for WCDMA \cite{3GPP09}.

To alleviate this problem for communication systems, researchers have developed many different methods. These include OFDM-based waveform design, equalizers, diversity techniques, and coding algorithms that involve interleaving and multiple input multiple output (MIMO). But there is one important difference between communication and navigation systems. For communication systems delays induced by reflections are not of importance. The goal of an equalizer is not to remove absolute delay but to remove relative delay among the reflected signals. This is not true for a navigation system. Absolute delay directly affects the RMS error. An example is a receive signal from single reflected signal in a communication system. Equalization would not be required since there is zero delay spread. Prior art examples of techniques to resolve these issues include US Patent Application No. 2010/0309051 to Moshfeghi, entitled Method And System For Determining The Positioning Of A Mobile Device, where a moving scanner captures RF waves and processes these signals to characterize them and at the same time the transmission channel information including location information is a stored reference for future comparison. The method applied assumes multipath signals and corrects or interpolates the multipath effects. The limitation though is a heavy reliance on prior historical channel information stored in a database will yield accurate current location information when multipath signals are included.

As discussed many of these solutions approach enhancements over previous technology advancements. However, to bridge the gap felt by commercial users and the US Department of Defense a need for more robust and comprehensive alternative to GPS satellite based solutions, AGPS or DGPS solutions or cellular service based solutions still exists.

### SUMMARY

The present invention is a method and system for a cooperative network that allows for accurate positioning by utilizing a number of nodes in combination that may or may not be used in conjunction with SoOP or Global Navigation Satellite System (GNSS), of which GPS is one type, based navigation. The core capability of the cooperative network is that each node has the ability to not only receive GNSS/SoOP from selected sources but also to generate beacon, or positioning, signals that can be utilized by other users in the network. In this way, both global and local positioning is possible. Global positioning is provided by the known locations of the SoOP. By contrast, local positioning enables signals generated via the cooperative network. Extending coverage with a cooperative network provides for positioning to users outside of the range of the SoOP. This concept is illustrated in FIG. 1.

In addition to extending coverage beyond the coverage area of the fixed wireless or satellite signal sources, we use the network to extend coverage inward. In this scenario, the network can be viewed as a multi-resolution solution to the navigation problem which has the potential to be used for multipath fading mitigation. A multi-resolution solution to robust navigation involves a coarse estimate with terrestrial or satellite signals and a finer estimate with the cooperative network.

The system and methods described herein are particularly advantageous particularly in the ability to extend coverage to users collaboratively. Emergency responders and our military can greatly benefit from ad hoc collaborative positioning information particularly for mission critical situations. Additionally, the systems and methods incorporated within offer a solution to the problem of multipath fading, one which continues to plague communication systems today.

Our novel approach to diversity of signals and to collaborative sharing of positioning information will be readily apparent from the Detailed Description of Embodiments when considered in conjunction with the accompanying diagrams.

### DETAILED DESCRIPTION OF THE EMBODIMENTS

In our description, we make reference to accompanying figures which are provided for illustrative purposes. It should be understood that other forms of these embodiments may exist that are still within the scope of the present invention.

System Overview

In one embodiment of this invention, users form a cooperative navigation network in order to derive their position coordinates and provide inter-node communication. This network has the ability to use signals from terrestrial base stations such as DTV, cellular signals such as Wideband Code Division Multiple Access (WCDMA) or GNSS signals to derive the position estimate. Our invention is comprised of a time-difference-of-arrival (TDOA) system whereby a plurality of signals towers is employed. In this terminology, towers refers to fixed wireless towers, such as cellular and DTV, etc., and satellites. This allows users to estimate and share parameters such as pseudoranges, timing and frequency offsets, and others, which removes the timing uncertainty from each tower.

In one of the embodiments of this invention to support GNSS and SoOP positioning, we employ a cooperative navigation network that maintains the ability to share positioning related information while also providing communication capability that uses mobile wireless access (MWA) mode. MWA mode refers to network capability that is provided by a wireless provider such as the case for mobile cellular service providers, Wi-Fi, and a plurality of other network service providers

In another embodiment of this invention to support GNSS and SoOP positioning, we employ a cooperative navigation network that maintains the ability to share positioning related information while also providing communication capability that uses mobile ad hoc network (MANET) mode. MANET mode refers to network capability that is provided by users within the cooperative network.

In another embodiment of this invention, the users generate and distribute position signals among themselves. These are referred to as beacon signals. This allows users to derive their positions without the need for signal towers. In this scenario, users coordinate the transmission and reception of these beacon signals. These signals may be RF, optical, or other signals. The timing, power, or phase of these signals may be used as part of the cooperative network algorithm to determine the position of users within the network.

In another embodiment of this invention, users (nodes) may employ a combination of signal towers and beacon signals to determine their respective positions. Similar to the aforementioned cases, users share information related to the location, power, timing, phase, etc. of these respective signal in order to estimate theirs, and the possible positions of other users in the network. An algorithm is used to determine the positions and timing uncertainties of users.

In an embodiment of the cooperative navigation network, users in the network are able to derive their positions in an absolute (Earth based) or a relative reference frame. Absolute positioning herein is referred to as global positioning. Relative positioning is referred to as local positioning.

There are three potential node types. They are:
a. Type 1—nodes that have access to SoOP/GNSS signals. In reference to FIG. 1, mobile nodes with access to SoOP such as DTV, WCDMA, CDMA2000, LTE or satellite signals, marked as 101, can locate themselves globally.
b. Type 2—nodes that have no navigation capability and must derive their positions from other nodes. Marked as 201 in FIG. 1 are nodes that desire the aid of beacon nodes which have positioned themselves globally or locally. Type 2 nodes suffer from the non-availability of any form of positioning signals from GNSS/SoOP. Beacon nodes are equipped with a waveform that maintains both positioning and communication functionality, or 202 MANET link in FIG. 1. These can be either RF, optical or other signals. The timing, power, or phase of these signals may be used to determine the positions of the “disadvantaged” nodes.
c. Type 3—nodes that have limited positioning capability and that are dependent upon other nodes to provide a fixed reference in order to obtain position. These nodes, 301 in FIG. 1, utilize a combination of SoOP, GNSS and beacon signals for positioning due to limited availability of signals and share the characteristics of Type 2 nodes. Partial resolution will include timing measurements on satellites in view with corresponding uncertainty using Type 1 nodes. This type incorporates a MWA link or 302 in FIG. 1.

In the embodiment of this invention, when a user derives their position, they maintain the ability to act as a node in the cooperative network that using beacon signals. That is one of the core capabilities illustrated in FIG. 1. The key advantage is that these beacon signals can be derived from the communication signals in MANET mode. This is the same approach that has been taken with SoOP; namely utilizing existing communication signals for positioning purposes.

Multipath fading is a critical factor in positioning accuracy. In another embodiment of this invention, the cooperative network is used to improve multipath performance. This is done by utilizing a diversity of signal sources which is the core of our cooperative network that provides solution to multipath fading. A simple example is as follows using the nodes outlined in FIG. 1 regardless of type:
Any user described here as the first user determines their position in a faded environment and informs the network
A second user determines their position in a non-faded environment
The second user measures the first user position relative to itself
The second user finds an error between its estimate and that provided by the first user

In another embodiment of this invention, the cooperative navigation network has the ability to support relative positioning as compared to geolocation for users outside the range of SoOP/GNSS signals. This is particularly advantageous if no positioning signals are available, say as in tunnels, and positions relative to a user-defined coordinate system are advantageous. More nodes can be added provided they have access to enough other nodes and SoOP/GNSS signals to calculate a position. In this way the footprint, or service, to disadvantaged nodes can be extended. With this approach once position estimates have been obtained for all nodes, they become part of a much more robust navigation system.

For cooperative network in MANET mode, there are a plurality of potential candidates that include but are not limited to Bluetooth, 3GPP Long Term Evolution, Wi-Fi, WiMAX and Zigbee. This embodiment assumes that a multitude of current and future networks may be utilized.

Positioning in a Cooperative Network

For a synchronous navigation system, the pseudorange for the m^{th} device from the k^{th} signal source or station is expressed as

ρₘ^{(k)}(t)=r^{(k)}(t,t−τ)+c(δtₘ(t)−δt^{(k)}(t−τ))+εₘ^{(k)}(t) (1)

where τ is the delay from when the signal was sent from the station to the time it was received at the mobile, δtₘ(t) and δt^{(k)} are the mobile and station clock offsets respectively, εₘ^{(k)}(t) are the nuisance parameters and c is the speed of light. Dropping time dependence and incorporating the speed of light into clock bias, the equation can be rewritten as

ρₘ^{(k)}=∥xₘ−x^{(k)}∥+bₘ−b^{(k)}+εₘ^{(k)} (2)

where x is the two-dimensional position co-ordinates vector. Each new station adds an additional clock bias term and to remove the uncertainty of station clock bias' requires measurements from the two different locations. Instead of using the fixed infrastructure estimate the clock bias and transmit the information, individual users derive their pseudoranges and share them via cooperative network.

To remove station clock bias, pseudorange difference between mobile i and j relative to station k is defined as

dᵢⱼ^{(k)}=ρᵢ^{(k)}−ρⱼ^{(k)}=∥xᵢ−x^{(k)}∥−∥xᵢ−x^{(k)}∥+bᵢ−bⱼ+εᵢⱼ^{(k)} (3)

The differential pseudorange is defined as δρᵢ^{(k)}=ρᵢ^{(k)-ρ}ₒ_{ᵢ}^{(k)} where ρₒ_{ᵢ}^{(k)} is the pseudorange estimated for user i relative to station k that is derived from user i's estimated position. Combining these differentials for all the stations into a single set of equations yields

δρᵢ=Gᵢδzᵢ+εᵢ (4)

where Gᵢ is the geometry matrix of the form

$$[ \begin{matrix}{( - {1}^{( 1 )} )}^{†} 1 \\ ⋮ \\ {( - {1}^{( k )} )}^{†} 1\end{matrix} ]$$

and 1^{(l)} the normalized vector from user i to station l. Defining the vector δzᵢ=[δxᵢ δyᵢ bᵢ]^{†} which encompasses both position and clock bias error estimated, the extension to multiuser scenario for cooperative network is straightforward. The difference in differential pseudoranges is given as δdᵢⱼ=(ρᵢ^{(k)}−ρₒ_{ᵢ}^{(k)})−(ρⱼ^{(k)}−ρₒ_{ⱼ}^{(k)})=δρᵢ^{(k)}−δρⱼ^{(k)}. Writing the equations in standard form

$$δ d = [ \begin{matrix}{( - {1}^{( 1 )} )}^{†} {( - {1}^{( 1 )} )}^{†} 1 \\ ⋮ \\ {( - {1}^{( k )} )}^{†} {( - {1}^{( k )} )}^{†} 1\end{matrix} ] [ \begin{matrix}δ {x}_{i} \\ δ {x}_{j} \\ δ {b}_{i} - δ {b}_{j}\end{matrix} ] + {ɛ}_{ij} \qquad ( 5 )$$

In one embodiment of this invention, least-squares estimation is used to resolve the position coordinates and differential clock bias between users.

In another embodiment of this invention, convex optimization is used to resolve the position coordinates and differential clock bias. This is necessary due to the fact that in some cases the accuracy of the least-squares estimate is not sufficient. On the other hand, convex optimization can greatly improve accuracy of the position and timing estimates.

Algorithmic Description

FIG. 2 illustrate implementation of positioning using SoOP/GNSS respectively. The first step is to search for positioning signals from SoOP/GNSS. This search may be a function of frequency, time, and spatial parameters. GNSS requires that the position of satellites and corresponding movement needs to be known. SoOP positioning requires knowledge of tower locations such as DTV, WCDMA, GSM, etc.

This information may come from the positioning signals themselves, such as in the case of GNSS. In one embodiment of the invention, SoOP tower locations and other important information, such as scrambling codes for WCDMA, may exist in a system database on a server and be accessed via MWA mode.

In another embodiment this information is transmitted to users via the cooperative network at network registration or via broadcast signals via MANET mode. It is assumed that user does not have enough information about which signals at present can be utilized or there are uncertain factors in dynamic environment.

In another embodiment of our invention, the system provides for dynamic network updates. This is to user to determine which signals to search for in time-varying environment.

In another embodiment of this invention, the user terminal performs spectrum sensing for signal detection to determine which signals are present. The user utilizes the system database as a starting point for the positioning signal selection process. At step 2, user will have a pool of candidate signals and it needs to pick up the best signal set to continue. The decision is based on comprehensive evaluation and may include signal power, signal source geometric distribution, multipath fading, and other parameters. Following the decision process, the user receiver is tuned to the selected signals and receives corresponding data.

In another embodiment of this invention, implementation of digital signal processing is used to improve the signal's navigation performance as shown in step 3. This includes correlation, multipath fading mitigation, interference cancellation, and others. Because of the diversity of SoOPs, the DSP processing on each kind of signal is distinct.

In Step 4 a pseudorange measurement is calculated based upon signal tower position from the system database. In cooperative network, the absolute timing is not strictly required on each node. Users can rely on relative measurement to estimate pseudorange.

Step 5 calculates the position estimate as described in the previous section. This step requires the retrieval of signal source position information from system database. User position coordinates, such as latitude, longitude and altitude are estimated. In terms of real time navigation, the workflow after step 5 goes back to step 1 for the next iteration. In one embodiment of this invention, every node not only can derive its own position in the network, but also can contribute to the other network participants.

In another embodiment of this invention, step 6 and step 7 utilize the cooperative navigation network and broadcast its position information to other accessible network nodes. In this scenario, information can be transmitted via the cooperative network are other wireless or wired networks. Beacon processing is not required at this point so other networks may be used to send the necessary information.

Another embodiment of the invention in MANET mode is shown in FIG. 3. This illustrates MANET node where users have not access to SoOP/GNSS but can achieve positioning within the mobile ad hoc network. The first step is to search for beacon signals. Unlike the node using SoOPs/GNSS, the beacon signal specification is known for MANET nodes. They can directly connect with each other and retrieve navigation information.

Step 2 includes interaction between beacon sources and user terminal and information dissemination. The user sends requests for positioning and will receive responses such as how many beacons are available and corresponding location.

At step 3, the user selects the best beacon signal set. The selection criteria may be made based upon estimates of beacon quality, user locations within the network, and others.

Step 4 is similar to Step 5 of FIG. 2. In another embodiment of this invention, the user here may not need a database. Instead, the cooperative network user's position information may be encoded with the beacon signal and sent simultaneously. Here the mechanism is more similar to satellite navigation.

In a cooperative navigation network, the dynamic nature of the network may affect navigation precision. Therefore the real time iteration from step 1 to step 4 is very important here. Once the user position is derived, the user may become a signal beacon for any other users in the network.

Conclusion, Ramifications, and Scope

As we have addressed herein, the previous embodiments demonstrate the value of a solution not dependent upon GPS receivers and satellites for determining positioning of a mobile node. The ability to utilize a MANET to coordinate signal acquisition, node positioning, and to transfer information collaboratively enhances navigation and communication capabilities beyond today's implementation. This provides a more robust solution less dependent upon GPS receivers which are subject to jamming (intentional or unintentional) and to multipath fading. Sharing of navigation via beacon signals puts less dependence on upon GPS receivers and cellular infrastructure to triangulate positioning. The ability to better control or significantly reduce multipath fading is a solution which communication users have long desired a solution.

Herein we have addressed embodiments of the invention, however, it is apparent that many more embodiments exist and that the scope of its functionality can be greatly enhanced. While the above description contains much specificity, these should not be construed as limitations on the scope of any embodiment, but as exemplifications of various embodiments thereof. Many other ramifications and variations are possible within the teachings of the various embodiments. For example MANET is identified as a Mobile Ad-hoc network and is not limited to LTE, Wi-Fi, Bluetooth, etc. Thus the scope should be determined by the appended claims and their legal equivalents, and not solely the by examples given.

### BRIEF DESCRIPTION OF THE DRAWINGS

Preferred embodiments of the present inventions taught herein are illustrated by example, and not by way of limitation, in the figures of the accompanying figures:

FIG. 1 is a diagram illustrating one example embodiment of a Cooperative Navigation System configured in accordance with the invention;

FIG. 2 is a flow chart illustrating one example embodiment of a method for navigation using SoOP/GNSS signals within the system of FIG. 1 in accordance with the invention; and

FIG. 3 is a flow chart illustrating one example embodiment of a method for navigation using beacon signals within the system of FIG. 1 in accordance with the invention.

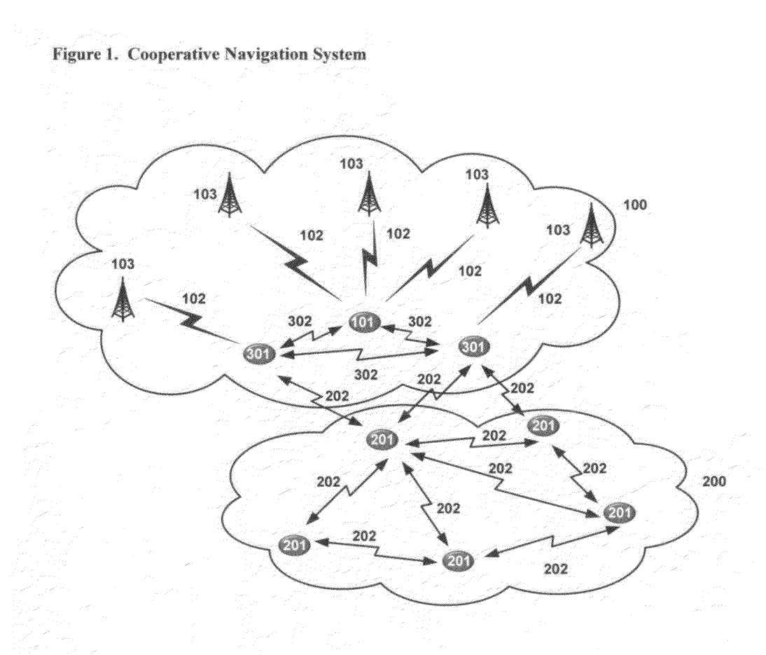

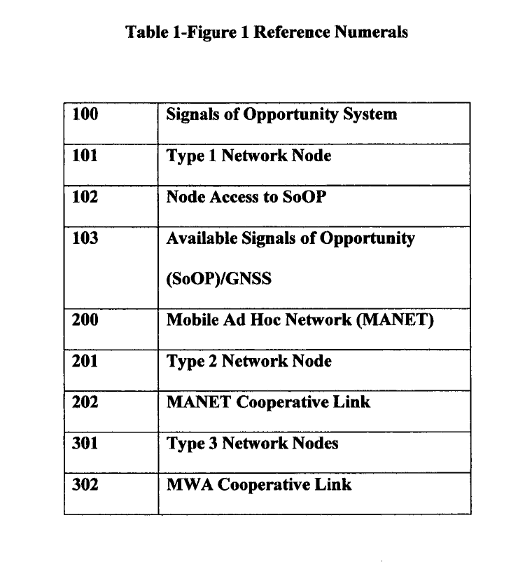

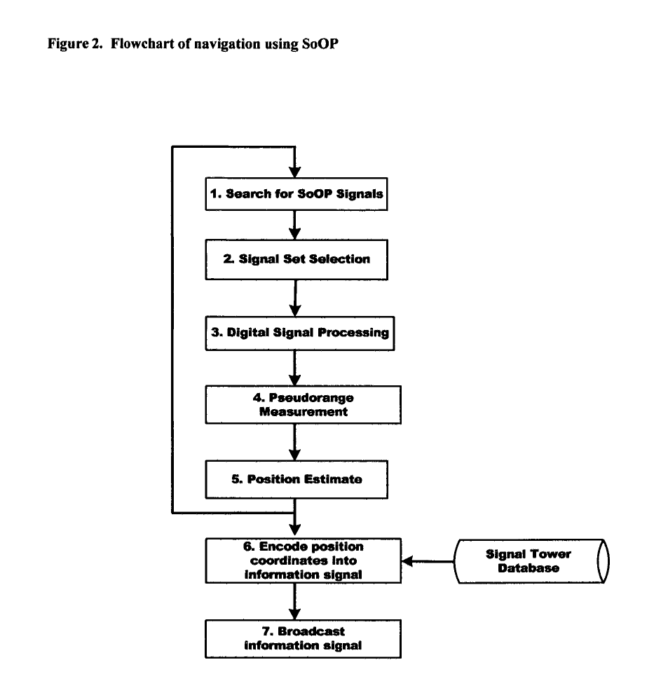

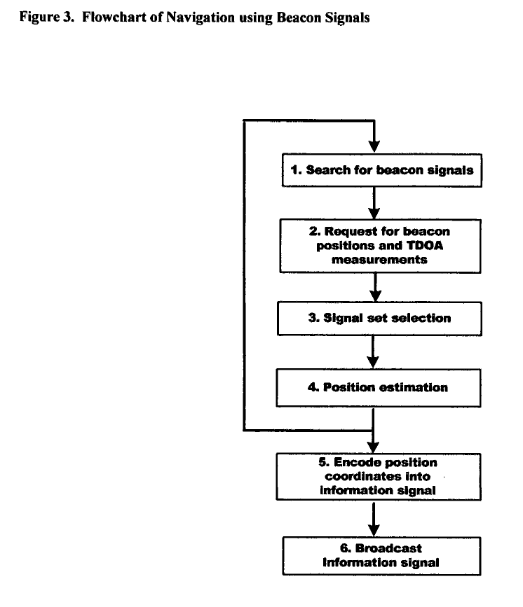

What is claimed is:

1. A method for determining the positioning of a user terminal, comprising:
a) an ad-hoc network;
b) a node in an ad-hoc network;
c) a plurality of available Radio Frequency (RF)/GNSS signals;
d) a software algorithm for receiving and processing RF/GNSS signals;
e) providing user location from processed RF/GNSS signals;
f) sending and receiving a plurality of navigation and communication signals to/from other users in the network whereby positioning information is collaboratively shared.

2. The method of claim 1, sending a navigation waveform distinctive from other users in the network.

3. The method of claim 1, receiving and evaluating other navigation signals according to a signal quality metric.

4. The method of claim 1, sending the signal quality metrics to a plurality of other user terminals in the network.

5. The method of claim 1, selecting the final set of signals to be used by each terminal according to a selection algorithm.

6. The method of claim 1, determining a pseudo-range between the user terminal and each transmitter based on the transmitted signals and the metrics from the other users.

7. The method of claim 1, determining a position of the user terminal based on the pseudo-ranges and a location of each of the transmitters.

8. The method of claim 1,wherein the user terminals search for signals contained in a table.

9. The method of claim 1,wherein the user terminals begin the signal search based on their last known position.

10. The method of claim 1, wherein the table containing signal search information is transmitted to the users by another user terminal.

11. A method for determining the positioning of a user terminal, comprising:
a) an ad-hoc network;
b) a node in an ad-hoc network;
c) a plurality of available user generated beacon signals;
d) a software algorithm for receiving and processing user generated beacon signals;
e) providing user location from processed user generated beacon signals;
0 sending and receiving a plurality of user generated beacon signals to/from other users in the network whereby positioning information is collaboratively shared.

12. The method of claim 11, sending a user generated beacon signal distinctive from other users in the network.

13. The method of claim 11, receiving and evaluating other user generated beacon signals according to a signal quality metric.

14. The method of claim 11, sending the user generated beacon signal quality metrics to a plurality of other user terminals in the network.

15. The method of claim 11, selecting the final set of user generated beacon signals to be used by each terminal according to a selection algorithm.

16. The method of claim 11, determining a pseudo-range between the user terminal and each transmitter based on the transmitted user beacon signals and the metrics from the other users.

17. The method of claim 11, determining a position of the user terminal based on the pseudo-ranges and a location of each of the user generated beacon signals.

18. The method of claim 11,wherein the user terminals search for user generated beacon signals contained in a table.

19. The method of claim 11,wherein the user terminals begin the user generated beacon signal search based on their last known position.

20. The method of claim 11, wherein the table containing user generated beacon signal search information is transmitted to the users by another user terminal.

21. The method of claim 11, wherein a user transmits a user generated beacon signal along with information containing its known location.

22. A method for determining the positioning of a user terminal, comprising:
g) an ad-hoc network;
h) a node in an ad-hoc network;
i) a plurality of available Radio Frequency (RF)/GNSS signals;
j) a software algorithm for receiving and processing RF/GNSS signals;
k) providing user location from processed RF/GNSS signals and user generated beacon signals
l) sending and receiving a plurality of navigation, communication and user generated beacon signals to/from other users in the network whereby positioning information is collaboratively shared

23. The method of claim 22, sending a navigation waveform distinctive from other users in the network.

24. The method of claim 22, receiving and evaluating signals according to a signal quality metric.

25. The method of claim 22, sending the signal quality metrics to a plurality of other user terminals in the network.

26. The method of claim 22, selecting the final set of signals to be used by each terminal according to a selection algorithm of signals.

27. The method of claim 22, determining a pseudo-range between the user terminal and each transmitter based on the transmitted signals and the metrics from the other users.

28. The method of claim 22, determining a position of the user terminal based on the pseudo-ranges and a location of each of the transmitters.

29. The method of claim 22,wherein the user terminals search for signals contained in a table.

30. The method of claim 22,wherein the user terminals begin the signal search based on their last known position.

31. The method of claim 22, wherein the table containing signal search information is transmitted to the users by another user terminal.

32. The method of claim 22, wherein a user transmits a user generated beacon signal and information containing its known location to other users.
